(19) United States
(12) Patent Application Publication
(10) Pub. No.: US 2001/0018679 A1
(43) Pub. Date: Aug. 30, 2001

(54) Communication system and method for performing an electronic-card settlement through an internet network

(76) Inventor: Soo Sung Lee, Seoul (KR)

Correspondence Address: STAAS & HALSEY LLP, 700 11TH STREET, NW, SUITE 500, WASHINGTON, DC, 20001, US

(21) Appl. No.: 09/781,325

(22) Filed: Feb. 13, 2001

(30) Foreign Application Priority Data
Feb. 29, 2000 (KR) 2000-10244

(51) Int. Cl. G06F 17/60

(52) U.S. Cl. 705/39

(57) ABSTRACT

A communication system for performing an electronic-card settlement, includes: a communication network; an electronic-card terminal system, coupled to the communication network, for reading an electronic card to send an electronic-card settlement request; a bank account management system, coupled to the communication network, for managing a plurality of accounts including a card-member store account and an agent account; and an electronic-card settlement agent system, coupled to the communication network, for transferring an amount of money from the agent account to the card-member store account in response to the electronic-card settlement request, thereby performing the electronic-card settlement.

### FIELD OF THE INVENTION

The present invention relates to a communication system. More particularly, the present invention relates to a communication system and method for performing an electronic-card settlement through an Internet network.

### DESCRIPTION OF THE PRIOR ART

As a credit society has been developed, the use of a card increased. There are many cards issued by a department store and a card issue company, a debit card and a credit card issued by a bank, a transportation card for paying a bus fee, a card having both functions of the credit card and the transportation card, etc. When a customer employs the card to pay goods purchase money in a card-member store, a merchant of the card-member store should submit a card transaction receipt to a card transaction bank. Then, the card transaction bank pays the goods purchase money corresponding to the card transaction receipt to the merchant of the card-member store. It takes several days, e.g., a time period of two days to five days, to pay the goods purchase money to the merchant of the card-member store.

Where the customer pays in cash after purchasing goods through a Web site related to an electronic home shopping, there is a problem that, in order to transfer the cash from a bank account of the customer to that of the electronic home shopping, the customer should visit a customer transaction bank personally, access the Web site of the customer transaction bank through an Internet network, or employ a phone banking service.

Further, when a merchant computer system of a card-member store performs a communication sale based on a card settlement through the Internet network, a commission of 2.1% to 4.5% on the communication sale is charged to the card-member store. Because of the commission of 2.1% to 4.5% on the communication sale, there is a problem that the card settlement with respect to the communication sale is avoided by the card-member store. Furthermore, since banks and card issue companies are issuing their respective cards so as to increase the number of card members, there is a problem that the ordinary man should carry a wallet having many cards such as credit cards, debit cards, transportation cards and other cards.

### SUMMARY OF THE INVENTION

It is, therefore, an object of the present invention to provide a communication system and method capable of performing an electronic-card settlement service, an electronic-card charging service, a reservation service, a small business transaction service and a money transfer/remittance service through an Internet network.

It is, therefore, another object of the present invention to provide a communication system and method capable of reducing a time period taken to provide a card-member store with a settlement amount of money by performing an electronic-card settlement through an Internet network.

In accordance with a first aspect of the present invention, there is provided a communication system for performing an electronic-card settlement, comprising: a communication network; an electronic-card terminal means, coupled to said communication network, for reading an electronic card to send an electronic-card settlement request; a bank account management means, coupled to said communication network, for managing a plurality of accounts including a card-member store account and an agent account; and an electronic-card settlement agent means, coupled to said communication network, for transferring an amount of money from the agent account to the card-member store account in response to the electronic-card settlement request, thereby performing the electronic-card settlement.

In accordance with a second aspect of the present invention, there is provided a communication method for performing an electronic-card settlement, comprising the steps of: (a) reading an electronic card to send an electronic-card settlement request to an electronic-card settlement agent system through a communication network; (b) authenticating the validity of the electronic card; (c) deducting an amount of money from the electronic card; and (d) transferring the amount of money from an agent account to a card-member store account in response to the electronic-card settlement request, thereby performing the electronic-card settlement.

### BRIEF DESCRIPTION OF THE DRAWINGS

The above and other objects and features of the instant invention will become apparent from the following description of preferred embodiments taken in conjunction with the accompanying drawings, in which:

FIG. 1 is an exemplary block diagram illustrating a communication system for performing an electronic-card settlement in accordance with the present invention;

FIG. 2A is an exemplary block diagram illustrating a first type of an electronic-card terminal system contained in a communication system shown in FIG. 1;

FIG. 2B is an exemplary block diagram illustrating a second type of an electronic-card terminal system contained in a communication system shown in FIG. 1;

FIG. 2C is an exemplary block diagram illustrating a third type of an electronic-card terminal system contained in a communication system shown in FIG. 1;

FIG. 2D is an exemplary block diagram illustrating a fourth type of an electronic-card terminal system contained in a communication system shown in FIG. 1;

FIG. 3 is an exemplary block diagram illustrating an electronic-card reading/charging device contained in an electronic-card terminal system shown in FIG. 1;

FIG. 4 is an exemplary flow chart illustrating a method performing for an electronic-card settlement between an electronic-card terminal system and an electronic-card settlement agent system through an Internet network in accordance with the present invention;

FIG. 5 is an exemplary flow chart illustrating a method for performing an electronic-card charging service between an electronic-card terminal system and an electronic-card settlement agent system through an Internet network in accordance with the present invention;

FIG. 6A is an exemplary flow chart illustrating a method for performing a reservation service between an electronic-card terminal system and an electronic-card settlement agent system through an Internet network in accordance with the present invention;

FIG. 6B is an exemplary flow chart illustrating a method for employing an electronic card storing reservation information between an electronic-card terminal system and an electronic-card settlement agent system through an Internet network in accordance with the present invention;

FIG. 7 is an exemplary flow chart illustrating a method for performing a small business transaction service between an electronic-card terminal system and an electronic-card settlement agent system through an Internet network in accordance with the present invention;

FIG. 8 is an exemplary flow chart illustrating a method for performing an electronic-card settlement service among an electronic-card terminal system, a service provider system and an electronic-card settlement agent system through an Internet network in accordance with the present invention; and

FIG. 9 is an exemplary flow chart illustrating a method for performing a money transfer/remittance service among an electronic-card terminal system and an electronic-card settlement agent system through an Internet network in accordance with the present invention.

### DETAILED DESCRIPTION OF THE INVENTION

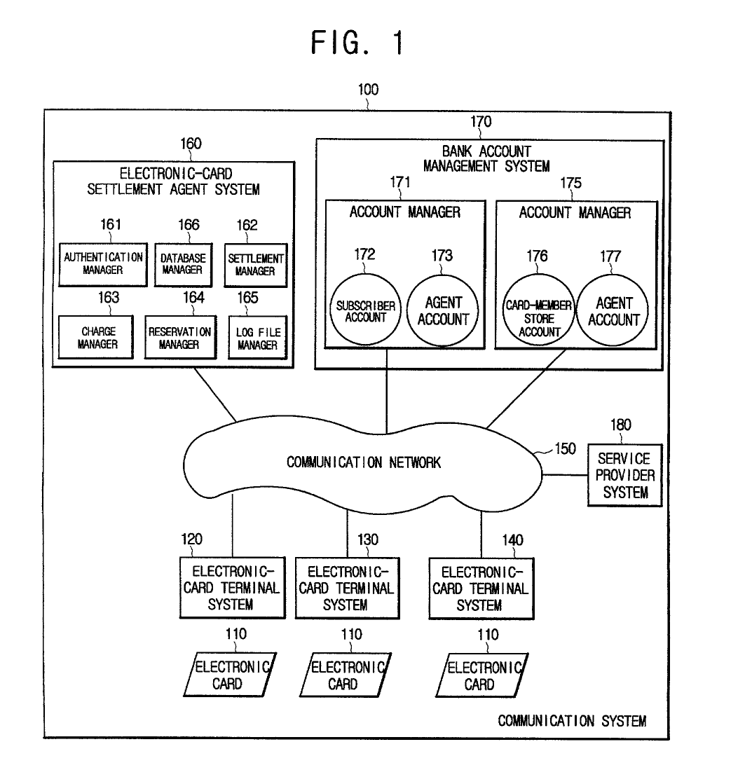

Referring to FIG. 1, there is shown an exemplary block diagram illustrating a communication system 100 for performing an electronic-card settlement. As shown, the communication system 100 includes electronic cards 110, electronic-card terminal systems 120, 130 and 140 located at a card-member store or an electronic-card charge place, a communication network 150, an electronic-card settlement agent system 160, an bank account management system 170 and a service provider system 180.

At first, each of the electronic cards 110 is an integrated card having various card functions, respectively. Each of the electronic-card terminal systems 120, 130 and 140, coupled to the communication network 150, reads and updates information written to the electronic card 110. Further, The electronic-card terminal system 120, 130 or 140 receives a subscriber-input data from a subscriber. The electronic-card settlement agent system 160 is coupled to the communication network 150 and responsive to an electronic-card settlement request outputted from the electronic-card terminal system 120, 130 or 140 at the card-member store. The electronic-card settlement agent system 160 pays money to the card-member store instead of the subscriber. The bank account management system 170 manages accounts of the subscriber, the card-member store and an agent corresponding to the electronic-card settlement agent system 160. The service provider system 180 provides an electronic commerce service, a tax payment service and a Web site, related to an electronic home shopping, to the subscriber.

The electronic-card settlement agent system 160 includes an authentication manager 161, a settlement manager 162, a charge manager 163, a reservation manager 164, a log file manager 165 and a database manager 166. The authentication manager 161 authenticates the subscriber and the card-member store. The authentication manager 161 further authenticates the validity of the electronic card 110. The log file manager 165 manages a log file storing a detailed electronic-card transaction history. The log file can be used when a dispute with respect to the transaction history is caused. The database manager 166 stores and manages authentication information, bank account information and service transaction history information related to the subscriber and the card-member store.

The bank account management system 170 includes an account manager 171 located at a subscriber transaction bank and an account manager 175 located at a card-member store transaction bank. The account manager 171 located at the subscriber transaction bank manages a subscriber account 172 and an agent account 173. Similarly, the account manager 175 located at the card-member store transaction bank manages a card-member store account 176 and an agent account 177.

The electronic card 110 contains a unique card number representing information necessary to authenticate the validity of the electronic card 110. The electronic card 110 further contains information related to an amount of money available and information related to a reservation confirmation. The electronic-card terminal systems 120, 130 and 140 at the card-member store can be configured in various types according to characteristics of the card-member store.

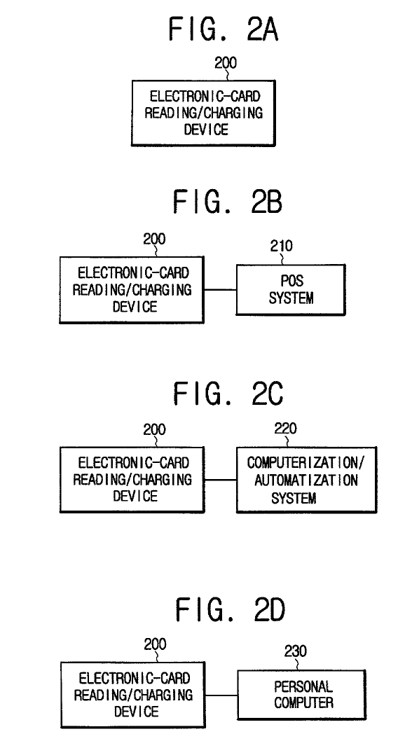

Referring to FIG. 2A, there is shown an exemplary block diagram illustrating a first type of the electronic-card terminal system 120, 130 or 140 contained in the communication system 100 shown in FIG. 1. As shown, the first type of the electronic-card terminal system 120, 130 or 140 can be implemented as an electronic reading/charging device 200 appropriate to the card-member store of a small scale. The electronic-card reading/charging device 200 can read electronic-card information written to the electronic card 110. The electronic-card reading/charging device 200 can further charge the electronic card 110 with a predetermined amount of money.

Referring to FIG. 2B, there is shown an exemplary block diagram illustrating a second type of the electronic-card terminal system 120, 130 or 140 contained in the communication system 100 shown in FIG. 1. As shown, the second type of the electronic-card terminal system 120, 130 or 140 includes the electronic-card reading/charging device 200 and a point-of-sale (POS) system 210 such as a lubrication system or a cash register. The second type of the electronic-card terminal system 120, 130 or 140 is appropriate to the card-member store of a medium and small scale.

Referring to FIG. 2C, there is shown an exemplary block diagram illustrating a third type of the electronic-card terminal system 120, 130 or 140 contained in the communication system 100 shown in FIG. 1. As shown, the third type of the electronic-card terminal system 120, 130 or 140 includes the electronic-card reading/charging device 200 and a computerization/automatization system 220. The computerization/automatization system 220 can control a reservation and an entrance and exit in a large-sized public performance place. The third type of the electronic-card terminal system 120, 130 or 140 is appropriate to the card-member store over the medium and small scale.

Referring to FIG. 2D, there is shown an exemplary block diagram illustrating a fourth type of the electronic-card terminal system 120, 130 or 140 contained in the communication system 100 shown in FIG. 1. As shown, the fourth type of the electronic-card terminal system 120, 130 or 140 includes the electronic-card reading/charging device 200 and a personal computer 230. The subscriber at the personal computer 230 can employ the electronic commerce service, the tax payment service and the Web site, related to the electronic home shopping, provided by the service provider system 180. Therefore, the subscriber at the personal computer 230 can employ the communication system 100 for the electronic-card settlement at home.

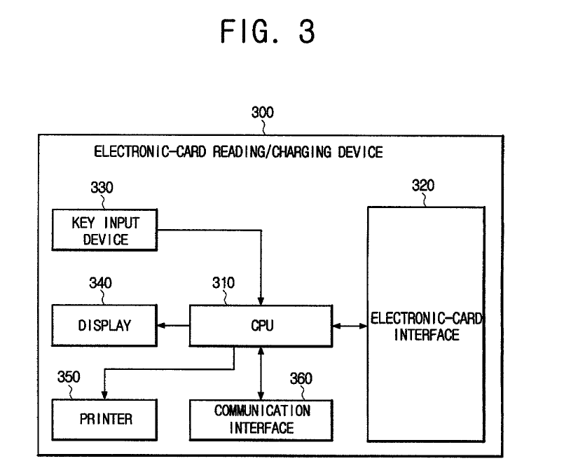

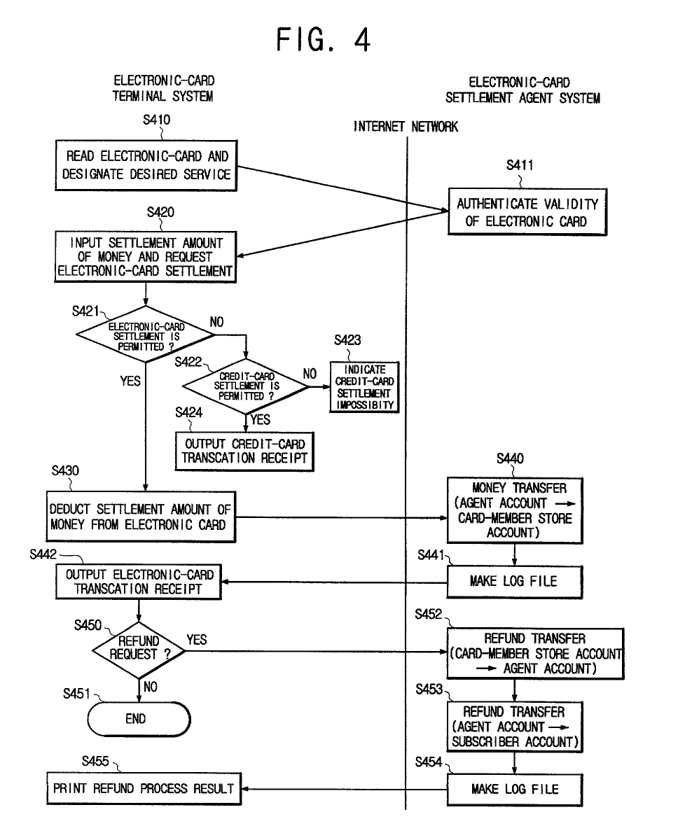

Referring to FIG. 3, there is shown an exemplary block diagram illustrating an electronic-card reading/charging device 300 contained in the electronic-card terminal system 120, 130 or 140 shown in FIG. 1. As shown, the electronic-card reading/charging device 300 includes a central processing unit (CPU) 310, an electronic-card interface 320, a key input device 330, a display 340, a printer 350 and a communication interface 360. The CPU 310 provides a service menu available in the communication system 100. The CPU 310 processes electronic-card read information and electronic write information. The CPU 310 controls the electronic-card interface 320, the display 340, the printer 350 and the communication interface 360. The electronic-card interface 320 reads and updates the electronic-card information written to the electronic card 110. The key input device 330 includes numeral keys and function keys so that the subscriber can input a subscriber-input data. The display 340 displays the electronic-card information. The printer 350 prints a service or electronic-card transaction receipt. The communication interface 360 provides a communication interface with an external system such as the electronic-card settlement agent system 160, the bank account management system 170 or the service provider system 180.

For example, in order to employ the electronic-card settlement service, the electronic-card charging service and the reservation service through the electronic card 110, the subscriber inserts the electronic card 110 into the electronic-card interface 320. At this time, the electronic-card interface 320 reads the electronic-card information, such as the card number and information related to the amount of money available. The electronic-card interface 320 sends the electronic-card read information to the CPU 310. The display 340 coupled to the CPU 310 displays the electronic-card read information so that the subscriber can confirm the electronic-card read information. The display 340 displays a service menu available at the communication system 100. The subscriber can designate a desired service in the service menu displayed on the display 340 by employing the key input device 330. The subscriber can input a settlement amount of money and request the electronic-card settlement. This electronic-card settlement request is sent to the electronic-card settlement agent system 160 via the communication interface 360. The electronic-card reading/charging device 300 obtains an electronic-card settlement acknowledgment corresponding to the electronic-card settlement request from the electronic-card settlement agent system 160. After obtaining the electronic-card settlement acknowledgment from the electronic-card settlement agent system 160, the CPU 310 deducts the settlement amount of money from the amount of money written to the electronic card 110 via the electronic-card interface 320. Then, the CPU 310 updates a balance of the electronic card 110 via the electronic-card interface 320. Then, the printer 350 provides an electronic-card transaction receipt to the subscriber. A communication connection between the electronic-card terminal systems 120, 130 and 140 and the electronic-card settlement agent system 160 can be accomplished by a public communication network such as the Internet network, a public telephone network, a satellite communication network and a radio communication network.

Referring to FIG. 4, there is shown an exemplary flow chart illustrating a method for performing the electronic-card settlement service between the electronic-card terminal system 120, 130 or 140 and the electronic-card settlement agent system 160 through an Internet network. To perform the electronic-card settlement service, the communication system 100 can employ the first, second or fourth type of the electronic-card terminal system 120, 130 or 140.

As shown, the electronic-card terminal system 120, 130 or 140 reads, at step S410, the card number and the information related to the amount of money available from the electronic card 110. Then, the electronic-card terminal system 120, 130 or 140 displays a service menu to the subscriber so that the subscriber at the electronic-card terminal system 120, 130 or 140 can designate the desired service from the service menu. The service menu includes the electronic-card settlement service, the money transfer/remittance service, the reservation service and the electronic-card charging service, etc. When the subscriber designates the electronic-card settlement service, the electronic-card terminal system 120, 130 or 140 informs the electronic-card settlement agent system 160 that the subscriber has designated the electronic-card settlement service. Simultaneously, the electronic-card terminal system 120, 130 or 140 sends the authentication information necessary to authenticate the validity of the electronic card 110, e.g., the card number, to the electronic-card settlement agent system 160.

Hereinafter, at step S411, the authentication manager 161 contained in the electronic-card settlement agent system 160 determines whether the electronic card 110 is valid. Then, the account manager 171 at the subscriber transaction bank confirms the subscriber account 172 corresponding to the electronic card 110. Then, the account manager 171 provides a confirmation result to the electronic-card terminal system 120, 130 or 140.

Hereinafter, if the electronic card 110 is valid, the electronic-card terminal system 120, 130 or 140 receives, at step S420, the information related to the settlement amount of money from the subscriber through the key input device 330. Further, the electronic-card terminal system 120, 130 or 140 receives the electronic-card settlement request from the subscriber. At step S421, the electronic-card terminal system 120, 130 or 140 determines whether the settlement amount of money is less than or the same as the amount of money written to the electronic card 110. If the settlement amount of money is not less than or the same as the amount of money written to the electronic card 110, at step S422, the electronic-card terminal system 120, 130 or 140 determines whether the subscriber wants a credit-card settlement. If the subscriber wants the credit card settlement, at step S424, the electronic-card terminal system 120, 130 or 140 makes and outputs a credit-card transaction receipt. Otherwise, if the subscriber does not want the credit card settlement, at step S423, the electronic-card terminal system 120, 130 or 140 displays a settlement impossibility indication to the subscriber through the display 340.

Otherwise, if the settlement amount of money is less than or the same as the amount of money written to the electronic card 110, at step S430, the electronic-card terminal system 120, 130 or 140 deducts the settlement amount of money from the amount of money written to the electronic card 110. The electronic-card terminal system 120, 130 or 140 writes the balance to the electronic card 110 after the deduction. The electronic-card terminal system 120, 130 or 140 informs the electronic-card settlement agent system 160 that the settlement amount of money has been deducted from the electronic card 110.

Hereinafter, the settlement manager 162 contained in the electronic-card settlement agent system 160 sends, at step S440, the settlement amount of money from the agent account 177 of the account manager 175 to the card-member store account 176 of the account manager 175. At this time, a predetermined commission is deducted from the settlement amount of money. The log file manager 165 contained in the electronic-card settlement agent system 160 makes, at step S441, a log file of an electronic-card transaction history containing a subscriber name, a card-member store name, a settlement date, the settlement amount of money, etc. A database contained in the database manager 166 stores the log file of the electronic-card transaction history. The electronic-card settlement agent system 160 informs the electronic-card terminal system 120, 130 or 140 that the money transfer has been completed. At step S442, the printer 350 contained in the electronic-card terminal system 120, 130 or 140 prints an electronic-card transaction receipt to the subscriber.

Hereinafter, at step S450, the electronic-card terminal system 120, 130 or 140 determines whether there is a refund request from the subscriber. If there is not the refund request from the subscriber, the electronic-card settlement is completed. Otherwise, if there is the refund request from the subscriber, the electronic-card terminal system 120, 130 or 140 sends the refund request from the subscriber to the electronic-card settlement agent system 160. At step S452, the electronic-card settlement agent system 160 transfers a refund from the card-member store account 176 of the account manager 175 to the agent account 177 of the account manager 175. At step S453, the electronic-card settlement agent system 160 transfers the refund from the agent account 173 of the account manager 171 to the subscriber account 172 of the account manager 171. At step S454, the electronic-card settlement agent system 160 makes the log file related to a refund process. Then, the database contained in the database manager 166 stores the log file related to the refund process. Then, at step S455, the printer 350 contained in the electronic-card terminal system 120, 130 or 140 prints a refund process result to the subscriber.

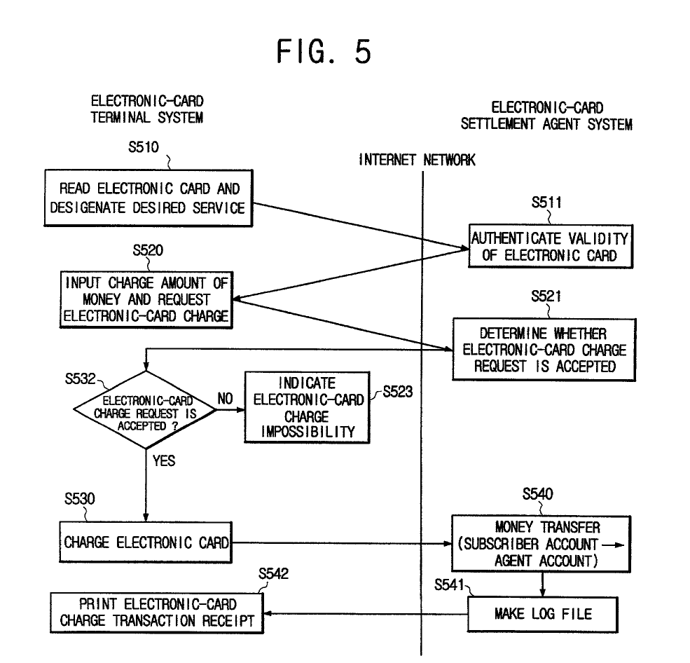

Referring to FIG. 5, there is shown an exemplary flow chart illustrating a method for performing the electronic-card charging service between the electronic-card terminal system 120, 130 or 140 and the electronic-card settlement agent system 160 through the Internet network. As shown, the electronic-card terminal system 120, 130 or 140 reads, at step S510, the card number and the information related to the amount of money available from the electronic card 110. Then, the electronic-card terminal system 120, 130 or 140 displays the service menu to the subscriber so that the subscriber at the electronic-card terminal system 120, 130 or 140 can designate the desired service from the service menu. The service menu includes the electronic-card settlement service, the money transfer/remittance service, the reservation service and the electronic-card charging service, etc. When the subscriber designates the electronic-card charging service, the electronic-card terminal system 120, 130 or 140 informs the electronic-card settlement agent system 160 that the subscriber has designated the electronic-card charging service. Simultaneously, the electronic-card terminal system 120, 130 or 140 sends the authentication information necessary to authenticate the validity of the electronic card 110, e.g., the card number, to the electronic-card settlement agent system 160.

Hereinafter, at step S511, the authentication manager 161 contained in the electronic-card settlement agent system 160 determines whether the electronic card 110 is valid. Then, the account manager 171 at the subscriber transaction bank confirms the subscriber account 172 corresponding to the electronic card 110. Then, the account manager 171 provides a confirmation result to the electronic-card terminal system 120, 130 or 140.

Hereinafter, if the electronic card 110 is valid, the electronic-card terminal system 120, 130 or 140 receives, at step S520, information related to a charge amount of money from the subscriber through the key input device 330. Further, the electronic-card terminal system 120, 130 or 140 receives the electronic-card charge request from the subscriber. Then, at step S521, the electronic-card settlement agent system 160 determines whether the electronic-card charge request can be accepted. Then, the electronic-card settlement agent system 160 sends a determination result to the electronic card terminal system 120, 130 or 140.

Hereinafter, at step S532, the electronic-card terminal system 120, 130 or 140 determines whether the charge amount of money is less than or the same as a balance of the subscriber account 172 of the subscriber transaction bank. If the charge amount of money is not less than or the same as the balance of the subscriber account 172, at step S523, the electronic-card terminal system 120, 130 or 140 displays a charge impossibility indication to the subscriber through the display 340. Otherwise, if the charge amount of money is less than or the same as the balance of the subscriber account 172, the electronic-card terminal system 120, 130 or 140 charges, at step S530, the electronic card 110 with the charge amount of money. Then, the electronic-card terminal system 120, 130 or 140 informs the electronic-card settlement agent system 160 that the electronic-card charge has been completed.

Hereinafter, the electronic-card settlement agent system 160 transfers, at step S540, the charge amount of money from the subscriber account 172 to the agent account 173. Then, the log file manager 165 makes the log file of an electronic-card charge history containing the subscriber name, the card-member store name, an electronic-card charge date, the charge amount of money, etc. The database contained in the database manager 166 stores the log file of the electronic-card charge history. At step S541, the electronic-card settlement agent system 160 informs the electronic-card terminal system 120, 130 or 140 that the money transfer has been completed. At step S542, the printer 350 contained in the electronic-card terminal system 120, 130 or 140 prints an electronic-card charge transaction receipt to the subscriber.

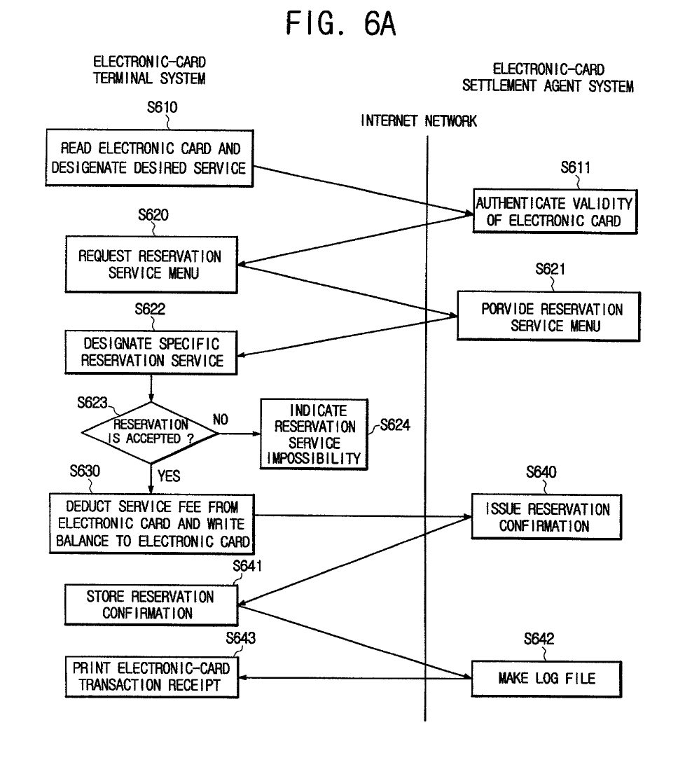

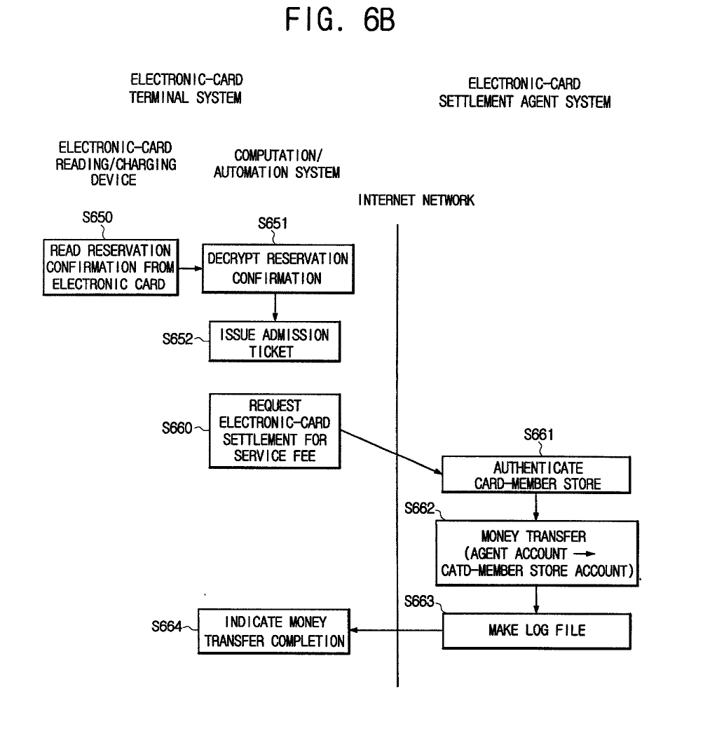

Referring to FIG. 6A, there is shown an exemplary flow chart illustrating a method for performing the reservation service between the electronic-card terminal system 120, 130 or 140 and the electronic-card settlement agent system 160 through the Internet network. To perform the reservation service, the communication system 100 can employ the first or fourth type of the electronic-card terminal system 120, 130 or 140.

As shown, the electronic-card terminal system 120, 130 or 140 reads, at step S610, the card number and the information related to the amount of money available from the electronic card 110. Then, the electronic-card terminal system 120, 130 or 140 displays the service menu to the subscriber so that the subscriber at the electronic-card terminal system 120, 130 or 140 can designate the desired service from the service menu. The service menu includes the electronic-card settlement service, the money transfer/remittance service, the reservation service and the electronic-card charging service, etc. When the subscriber designates the reservation service, the electronic-card terminal system 120, 130 or 140 informs the electronic-card settlement agent system 160 that the subscriber has designated the reservation service. Simultaneously, the electronic-card terminal system 120, 130 or 140 sends the authentication information necessary to authenticate the validity of the electronic card 110, e.g. , the card number, to the electronic-card settlement agent system 160.

Hereinafter, at step S611, the authentication manager 161 contained in the electronic-card settlement agent system 160 determines whether the electronic card 110 is valid. If the electronic card 110 is valid, the electronic-card terminal system 120, 130 or 140 requests, at step S620, a reservation service menu to the electronic-card settlement agent system 160.

Hereinafter, the reservation manager 164 contained in the electronic-card settlement agent system 160 provides, at step S621, the electronic-card terminal system 120, 130 or 140 with the reservation service menu containing service fees. Then, the subscriber designates, at step S622, a desired reservation service from the reservation service menu. Then, at step S623, the electronic-card terminal system 120, 130 or 140 determines whether a service fee corresponding to the desired reservation service is less than or the same as the amount of money available from the electronic card 110. If the service fee is not less than or the same as the amount of money available from the electronic card 110, the electronic-card terminal system 120, 130 or 140 informs, at step S624, the subscriber that the desired reservation service is not available. Otherwise, if the service fee is less than or the same as the amount of money available, the electronic-card terminal system 120, 130 or 140 deducts the service fee from the amount of money written to the electronic card 110. After the deduction, the electronic-card terminal system 120, 130 or 140 writes a balance to the electronic card 110. Then, at step S630, the electronic-card terminal system 120, 130 or 140 informs the electronic-card settlement agent system 160 that the service fee has been deducted from the electronic card 110.

Hereinafter, the electronic-card settlement agent system 160 issues, at step S640, a reservation confirmation containing an encrypted password to the electronic-card terminal system 120, 130 or 140, wherein the encrypted password can be decrypted by the electronic-card terminal system 120, 130 or 140 at a specific card-member store. Then, the electronic-card terminal system 120, 130 or 140 stores, at step S641, the reservation confirmation in the electronic card 110. Then, the electronic-card terminal system 120, 130 or 140 informs the electronic-card settlement agent system 160 that the reservation confirmation has been stored in the electronic card 110. Then, to prevent a dispute with respect to the transaction contents, the log file manager 165 of the electronic-card settlement agent system 160 makes, at step S642, a log file containing a reservation service history such as a subscriber name, a card-member store name, a reservation service date, the service fee, the reservation confirmation, etc. The log file is stored in the database contained in the database manager 166. Then, the electronic-card terminal system 120, 130 or 140 provides, at step S643, the electronic-card transaction receipt to the subscriber.

Referring to FIG. 6B, there is shown an exemplary flow chart illustrating a method for employing the electronic card 110 storing reservation information between the electronic-card terminal system 120, 130 or 140 and the electronic-card settlement agent system 160 through the Internet network. As shown, the electronic-card reading/charging device 200 contained in the electronic-card terminal system 120, 130 or 140 reads, at step S650, the reservation confirmation written to the electronic card 110 to send the reservation confirmation to the computerization/automatization system 220 contained in the electronic-card terminal system 120, 130 or 140. Then, the computerization/automatization system 220 decrypts, at step S651, the reservation confirmation so as to determine the validity of the reservation confirmation. Then, the computerization/automatization system 220 stores the reservation confirmation. Then, the computerization/automatization system 220 issues, at step S652, an admission ticket to the subscriber.

Hereinafter, the computerization/automatization system 220 sends, at step S660, the reservation confirmation, the card-member store number and the electronic-card settlement request to the electronic-card settlement agent system 160. Then, the electronic-card settlement agent system 160 authenticates, at step S661, the card-member store. Then, the electronic-card settlement agent system 160 transfers the service fee from the agent account 177 to the card-member store account 176. At this time, a predetermined commission is deducted from the service fee. Then, to prevent a dispute with respect to the transaction contents, the log file manager 165 of the electronic-card settlement agent system 160 makes, at step S663, a log file containing a service settlement history. The log file is stored in the database contained in the database manager 166. Then, at step S664, the electronic-card settlement agent system 160 informs the computerization/automatization system 220 that the service fee has been transferred from the agent account 177 to the card-member store account 176.

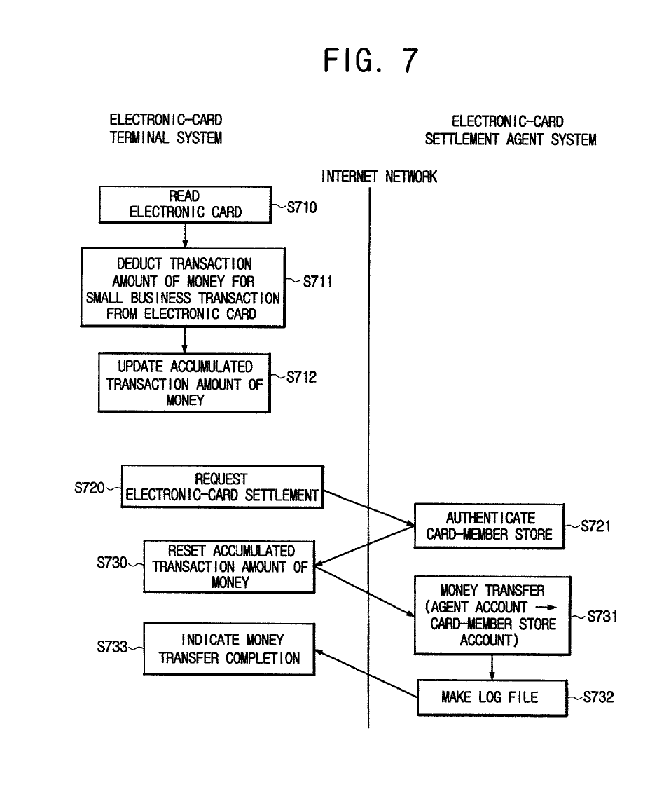

Referring to FIG. 7, there is shown an exemplary flow chart illustrating a method for performing the small business transaction service between the electronic-card terminal system 120, 130 or 140 and the electronic-card settlement agent system 160 through the Internet network. For the small business transaction, the electronic-card terminal system 120, 130 or 140 needs the electronic-card reading/charging device 200 and the POS system 210 shown in FIG. 2B. Further, the electronic-card reading/charging device 200 needs a storage device, which can store an accumulated transaction amount of money.

As shown, the electronic-card terminal system 120, 130 or 140 reads, at step S710, the electronic card 110. Then, the electronic-card terminal system 120, 130 or 140 deducts, at step S711, a current transaction amount of money for the small business transaction from the electronic card 110. Then, the electronic card 110 updates, at step S712, a balance of the electronic card 110. Then, the electronic-card terminal system 120, 130 or 140 adds the current transaction amount of money to a previous transaction amount of money. Then, the electronic-card terminal system 120, 130 or 140 stores the sum of the current transaction amount of money and the previous transaction amount of money. Then, at step S720, the electronic-card terminal system 120, 130 or 140 sends its unique number, the settlement amount of money and the electronic-card settlement request to the electronic-card settlement agent system 160. Then, the electronic-card settlement agent system 160 authenticates, at step S721, the card-member store. If the card-member store is authenticated, the electronic-card settlement agent system 160 commands the electronic-card terminal system 120, 130 or 140 to reset the accumulated transaction amount of money.

Hereinafter, the electronic-card terminal system 120, 130 or 140 resets, at step S730, the accumulated transaction amount of money. Then, the electronic-card terminal system 120, 130 or 140 informs the electronic-card settlement agent system 160 that the accumulated transaction amount of money has been reset. Then, the electronic-card settlement agent system 160 transfers, at step S731, the current settlement amount of money from the agent account 177 to the card-member store account 176. At this time, a predetermined commission is deducted from the settlement amount of money. Then, to prevent a dispute with respect to the small business transaction contents, the log file manager 165 of the electronic-card settlement agent system 160 makes, at step S732, a log file containing a small business transaction history. The log file is stored in the database contained in the database manager 166. Then, at step S733, the electronic-card settlement agent system 160 informs the electronic-card terminal system 120, 130 or 140 that the settlement amount of money has been transferred from the agent account 177 to the card-member store account 176. Then, the electronic-card terminal system 120, 130 or 140 informs the subscriber that the money transfer has been completed, by employing the display 340 or the printer 350.

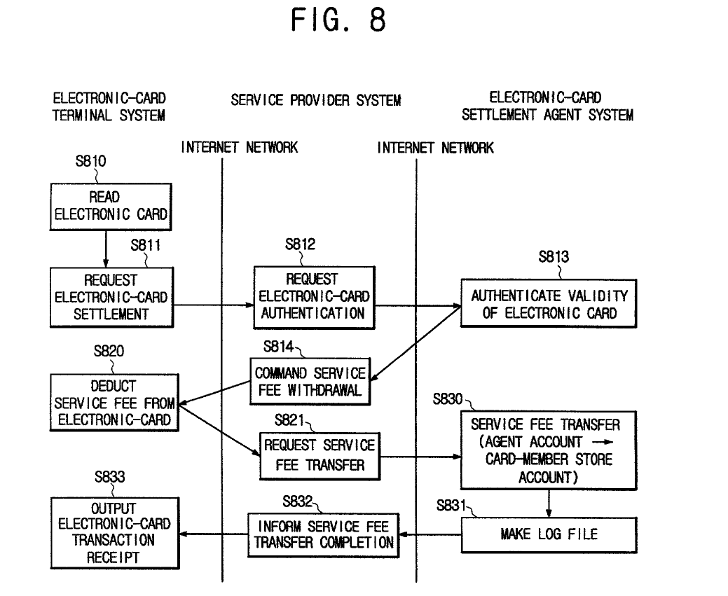

Referring to FIG. 8, there is shown an exemplary flow chart illustrating a method for performing the electronic-card settlement service among the electronic-card terminal system 120, 130 or 140 at the card-member store, the service provider system 180 and the electronic-card settlement agent system 160 through the Internet network. Preferably, the electronic-card terminal system 120, 130 or 140 includes the electronic-card reading/charging device 200 and the personal computer 230.

As shown, the electronic-card terminal system 120, 130 or 140 reads, at step S810, a card number from the electronic card 110. Then, the electronic-card terminal system 120, 130 or 140 sends, at step S811, the card number, information of the settlement amount of money related to a service fee and an electronic-card settlement request to the service provider system 180. Then, the service provider system 180 sends the card number and the information of the settlement amount of money to the electronic-card settlement agent system 160. Then, the service provider system 180 requests, at step S812, the electronic-card settlement agent system 160 to authenticate the electronic card 110.

Hereinafter, the authentication manager 161 of the electronic-card settlement agent system 160 determines, at step S813, the validity of the electronic card 110 to authenticate the electronic card 110. Then, if the electronic card 110 is valid, the electronic-card settlement agent system 160 determines whether the amount of money available in the electronic card 110 is less than or the same as the settlement amount of money. If the amount of money available in the electronic card 110 is not less than or the same as the settlement amount of money, the electronic-card settlement agent system 160 informs the service provider system 180 that the electronic-card settlement cannot be accomplished. Otherwise, if the amount of money available in the electronic card 110 is less than or the same as the settlement amount of money, the electronic-card settlement agent system 160 informs the service provider system 180 that the electronic-card settlement can be accomplished. Then, the service provider system 180 commands, at step S814, the electronic-card terminal system 120, 130 or 140 to withdraw the settlement amount of money from the electronic card 110.

Hereinafter, the electronic-card terminal system 120, 130 or 140 deducts, at step S820, the settlement amount of money from the amount of money written to the electronic card 110. After deduction, the electronic-card terminal system 120, 130 or 140 writes the balance to the electronic card 110. Then, the electronic-card terminal system 120, 130 or 140 informs the service provider system 180 that the settlement amount of money as the service fee has been deducted from the electronic card 110. Then, at step S821, the service provider system 180 requests the electronic-card settlement agent system 160 to transfer the service fee from the agent account 177 to the card-member store account 176.

Hereinafter, the electronic-card settlement agent system 160 transfers, at step S830, the service fee from the agent account 177 to the card-member store account 176. At this time, the predetermined commission is deducted from the service fee. Then, to prevent a dispute with respect to the transaction contents, the log file manager 165 of the electronic-card settlement agent system 160 makes, at step S831, a log file containing a service fee settlement history. The log file is stored in the database contained in the database manager 166. Then, at step S832, the electronic-card settlement agent system 160 informs the electronic-card terminal system 120, 130 or 140 that the service fee has been transferred from the agent account 177 to the card-member store account 176. Then, the electronic-card terminal system 120, 130 or 140 prints, at step S833, the electronic-card transaction receipt by employing the printer 350.

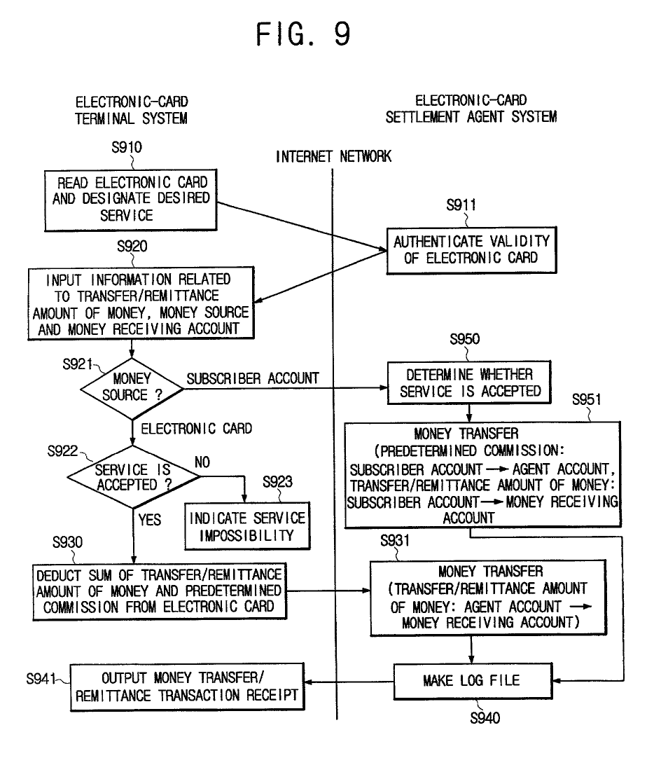

Referring to FIG. 9, there is shown an exemplary flow chart illustrating a method for performing a money transfer/remittance service among the electronic-card terminal system 120, 130 or 140 and the electronic-card settlement agent system 160 through the Internet network. To perform the money transfer/remittance service, the communication system 100 includes either the first or fourth type of the electronic-card terminal system 120, 130 or 140.

As shown, the electronic-card terminal system 120, 130 or 140 reads, at step S910, the card number and the information related to the amount of money available from the electronic card 110. Then, the electronic-card terminal system 120, 130 or 140 displays the service menu to the subscriber so that the subscriber at the electronic-card terminal system 120, 130 or 140 can designate one service from the service menu. The service menu includes the electronic-card settlement service, the money transfer/remittance service, the reservation service and the electronic-card charging service, etc. When the subscriber designates the money transfer/remittance service, the electronic-card terminal system 120, 130 or 140 informs the electronic-card settlement agent system 160 that the subscriber has designated the money transfer/remittance service. Simultaneously, the electronic-card terminal system 120, 130 or 140 sends the information, necessary to authenticate the validity of the electronic card 110, e.g., the card number, to the electronic-card settlement agent system 160. Then, at step S911, the authentication manager 161 contained in the electronic-card settlement agent system 160 determines whether the electronic card 110 is valid.

Hereinafter, if the electronic card 110 is valid, the subscriber inputs information related to a transfer/remittance amount of money, a money source and a money receiving account through the key input device 330. Then, at step S921, the electronic-card terminal system 120, 130 or 140 determines whether the money source is the electronic card 110 or the subscriber account 172. If the money source is the electronic card 110, at step S922, the electronic-card terminal system 120, 130 or 140 determines whether the sum of the transfer/remittance amount of money and a predetermined commission is less than or the same as the amount of money written to the electronic card 110. If the sum of the transfer/remittance amount of money and the predetermined commission is not less than or the same as the amount of money written to the electronic card 110, at step S923, the electronic-card terminal system 120, 130 or 140 displays a service impossibility indication to the subscriber through the display 340. Otherwise, if the sum of the transfer/remittance amount of money and the predetermined commission is less than or the same as the amount of money written to the electronic card 110, at step S930, the electronic-card terminal system 120, 130 or 140 deducts the transfer/remittance amount of money and the predetermined commission from the amount of money written to the electronic card 110. Then, at step S931, the electronic-card settlement agent system 160 transfers the transfer/remittance amount of money from the agent account 177 to a money receiving account, e.g., the card-member store account 176 or another subscriber account.

Hereinafter, to prevent a dispute with respect to the money transfer/remittance transaction contents, the log file manager 165 of the electronic-card settlement agent system 160 makes, at step S940, a log file containing a money transfer/remittance transaction history such as the subscriber name, the subscriber account, the money receiving account, the transaction date and the transfer/remittance amount of money. The log file is stored in the database contained in the database manager 166. Then, the electronic-card settlement agent system 160 informs the electronic-card terminal system 120, 130 or 140 that the money transfer has been completed. Then, the electronic-card terminal system 120, 130 or 140 informs, at step S941, the subscriber that the money transfer has been completed, by employing the display 340 or the printer 350.

Otherwise, if the money source is the subscriber account 172, at step S950, the electronic-card settlement agent system 160 determines whether the money transfer/remittance service can be accepted. Then, at step S951, the electronic-card settlement agent system 160 transfers the predetermined commission from the subscriber account 172 to the agent account 173. Further, the electronic-card settlement agent 160 transfers the transfer/remittance amount of money from the subscriber account 172 to the money receiving account. Then, the steps S940 and S941 are repeated.

As described above, the communication system and method in accordance with the present invention can reduce a time period taken to provide the card-member store with the settlement amount of money by performing the electronic-card settlement through the Internet network and the electronic-card settlement agent system.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A communication system for performing an electronic-card settlement, comprising:
a communication network;
an electronic-card terminal means, coupled to said communication network, for reading an electronic card to send an electronic-card settlement request;
a bank account management means, coupled to said communication network, for managing a plurality of accounts including a card-member store account and an agent account; and
an electronic-card settlement agent means, coupled to said communication network, for transferring an amount of money from the agent account to the card-member store account in response to the electronic-card settlement request, thereby performing the electronic-card settlement.

2. The communication system as recited in claim 1, wherein the electronic card includes a charged electronic card, which has functions of a credit card, a debit card, a department store card and a transportation card.

3. The communication system as recited in claim 1, wherein said electronic-card settlement agent means processes an electronic-card authentication, an electronic-card settlement service, an electronic-card charging service, a reservation service and a small business transaction service through an Internet network as said communication network.

4. The communication system as recited in claim 1, wherein said electronic-card settlement agent means includes a database for storing a service transaction history.

5. The communication system as recited in claim 1, further comprising:
a service provider system for providing an electronic commerce service, a tax payment service and a Web site related to an electronic home shopping.

6. The communication system as recited in claim 1, wherein said electronic-card terminal means includes:
a key input device for providing numeral keys and function keys so that a subscriber can input a subscriber-input data;
an electronic-card interface for reading and updating electronic-card information written to the electronic card;
a display for displaying read and write information of the electronic card;
a communication interface for providing a communication interface with said electronic-card settlement agent means and said bank account management means; and
a processing means for processing the user-input data and the electronic-card information to be written to the electronic card; and controlling said electronic-card interface, said display and said communication interface.

7. The communication system as recited in claim 1, wherein said electronic-card settlement agent means includes:
a means for authenticating the validity of the electronic card; and
a means for deducting a settlement amount of money from the electronic card; and updating a balance of the electronic card.

8. The communication system as recited in claim 1, wherein said bank account management means includes:
a first account manager at a subscriber transaction bank for managing a subscriber account and the agent account; and
a second account manager at a card-member store transaction bank for managing the agent account and the card-member store transaction bank.

9. A communication method for performing an electronic-card settlement, comprising the steps of:
(a) reading an electronic card to send an electronic-card settlement request to an electronic-card settlement agent system through a communication network;
(b) authenticating the validity of the electronic card;
(c) deducting an amount of money from the electronic card; and
(d) transferring the amount of money from an agent account to a card-member store account in response to the electronic-card settlement request, thereby performing the electronic-card settlement.

10. The communication method as recited in claim 9, wherein said step (d) further includes the steps of:
deducting a predetermined commission from the amount of money to be transferred; and
updating a balance of the electronic card.

11. The communication method as recited in claim 9, wherein said step (d) further includes the steps of:
after the electronic-card settlement agent system has transferred the amount of money, transferring a refund amount of money from the card-member store account to the agent account if there is a refund request from the electronic-card terminal system; and
transferring the refund amount of money from the agent account to a subscriber account.

12. The communication method as recited in claim 9, wherein said step (c) further includes the steps of:
determining whether a settlement amount of money is less than or the same as the amount of money written to the electronic card; and
if a settlement amount of money is less than or the same as the amount of money written to the electronic card, permitting the electronic-card settlement.

13. The communication method as recited in claim 9, wherein said step (a) further includes the steps of:
providing a service menu so that a subscriber at an electronic-card terminal system can designate a desired service.

14. The communication method as recited in claim 13, wherein the service menu includes an electronic-card settlement service, a money transfer/remittance service, a reservation service, a tax payment service and an electronic-card charging service.

15. The communication method as recited in claim 14, wherein the reservation service includes the steps of:
(s1) authenticating the validity of the electronic card if the electronic card is inserted into the electronic-card terminal system;
(s2) providing a reservation service menu so that the subscriber designates a specific reservation service;
(s3) if the subscriber designates the specific reservation service, determining whether the specific reservation service is accepted;
(s4) deducting a reservation service fee from the amount of money written to the electronic card and updating a balance of the electronic card;
(s5) generating reservation confirmation information to write the reservation confirmation information to the electronic card;
(s6) decrypting the reservation confirmation information to issue an admission ticket to the subscriber; and
(s7) transferring the reservation service fee from the agent account to the card-member store account after a predetermined time period.

16. The communication method as recited in claim 15, wherein said step (s4) further includes the step of:
deducting a predetermined commission from the reservation service fee when the reservation service fee is transferred.

17. The communication method as recited in claim 14, wherein the electronic-card charging service includes the steps of:
(p1) authenticating the validity of the electronic card in response to an electronic-card charge request if the electronic card is inserted into the electronic-card terminal system;
(p2) determining whether the electronic-card charging service is accepted;
(p3) charging the electronic card with a charge amount of money; and
(p4) transferring the charge amount of money from a subscriber account to the agent account.
